(19) United States
(12) Patent Application Publication
(10) Pub. No.: US 2022/0261656 A1
(43) Pub. Date: Aug. 18, 2022

(54) NON-TRANSITORY COMPUTER-READABLE RECORDING MEDIUM, INFORMATION PROCESSING APPARATUS, AND EVOLUTIONARY COMPUTATION METHOD

(71) Applicant: FUJITSU LIMITED, Kawasaki-shi (JP)

(72) Inventors: Toshihiko Mori, Isehara (JP); Yukito TSUNODA, Sagamihara (JP)

(73) Assignee: FUJITSU LIMITED, Kawasaki-shi (JP)

(21) Appl. No.: 17/735,147

(22) Filed: May 3, 2022

Related U.S. Application Data
(63) Continuation of application No. PCT/JP2019/048388, filed on Dec. 11, 2019.

(51) Int. Cl. G06N 3/08; G06K 9/62

(52) U.S. Cl. CPC G06N 3/086; G06K 9/6262

(57) ABSTRACT

A non-transitory computer-readable recording medium storing an evolutionary computation program in which a processor included in a computer executes a process, the process includes calculating fitness of a plurality of individuals based on a plurality of input in parallel in one generation, discontinuing, when a predetermined reference value at an end of a search for an eigensolution used to calculate the fitness of each of the plurality of individuals exceeds a threshold value, calculation of an individual in which the predetermined reference value exceeds the threshold value, and assigning an estimated fitness value to the individual for which the calculation is discontinued.

### CROSS-REFERENCE TO RELATED APPLICATION

This application is a continuation application of International Application PCT/JP2019/048388 filed on Dec. 11, 2019 and designated the U.S., the entire contents of which are incorporated herein by reference.

### FIELD

The embodiment discussed herein is related to an evolutionary computation program for parallel computing and the like.

### BACKGROUND

A genetic algorithm (GA) has been known as one of evolutionary computation (EC). According to the genetic algorithm, for example, an input value is converted into a bit string or the like and randomly generated, and selection (leaving one with favorable characteristics), mating, and mutation of input values are repeated, thereby finding an optimum input value.

Furthermore, a method using the GA for designing an optimum structure has been known. In a case of obtaining the optimum structure, fitness evaluation (performance evaluation) needs to be performed. In order to evaluate fitness, intensity distribution corresponding to a design structure needs to be obtained. In order to obtain the intensity distribution, it is indispensable to calculate an eigensolution that satisfies an eigensolution condition.

For example, surface acoustic wave (SAW) intensity distribution to be used to optimally design a SiO₂ layer structure of an optical SAW filter is obtained based on the formula (1). In order to obtain the SAW intensity distribution, it is indispensable to calculate an eigensolution that satisfies the eigensolution condition expressed by the formula (2). In this example, an eigensolution that converges to zero (B₁=0, Aₙ=0) at infinity needs to be calculated to obtain correct SAW intensity distribution.

$$\begin{matrix}[ Formula 1 ] & \\ SAW INTENSITY DISTRIBUTION S ( z ) : & FORMULA ( 1 )\end{matrix}$$

$$S ( z ) = \{ \begin{matrix}{A}_{i} Exp \{ {K}_{i} ( z - {zc}_{i} ) \} + {B}_{i} Exp \{ - {K}_{i} ( z - {zc}_{i} ) \} & ( {N}_{i} < Neff ) \\ {A}_{i} Cos \{ {K}_{i} ( z - {zc}_{i} ) \} + {B}_{i} Sin \{ - {K}_{i} ( z - {zc}_{i} ) \} & ( {N}_{i} > Neff )\end{matrix} \\ {K}_{i} = k \sqrt{\vert {N}_{i}^{2} - {Neff}^{2} \vert} \\ i : Layer No .$$

$$\begin{matrix}[ Formula 2 ] & \\ EIGENSOLUTION CONDITION & FORMULA ( 2 )\end{matrix}$$

$$[ \begin{matrix}{A}_{n + 1} \\ {B}_{n + 1}\end{matrix} ] = \overline{{M}_{n + 1} ( {zb}_{n} )} \cdot {M}_{n} ( {zb}_{n} ) \cdot \overline{{M}_{n} ( {zb}_{n - 1} )} \cdot {M}_{n - 1} ( {zb}_{n - 1} ) … \overline{{M}_{2} ( {zb}_{1} )} \cdot {M}_{1} ( {zb}_{1} ) [ \begin{matrix}{A}_{1} \\ {B}_{1}\end{matrix} ] \\ {M}_{i} ( z ) = [ \begin{matrix}{P}_{1} ( z ) & {Q}_{1} ( z ) \\ \frac{{dP}_{i} ( z )}{dz} & \frac{{dQ}_{i} ( z )}{dz}\end{matrix} ] AND {A}_{1} = 1 , {B}_{1} = 0 , {A}_{n} = 0$$

Furthermore, the GA is used to optimally design the SiO₂ layer structure of the optical surface acoustic wave (SAW) filter. FIG. 10 is a diagram illustrating a reference example of optimum structure design for SiO₂ layer arrangement. As illustrated in FIG. 10, the optical SAW filter extracts signals of a specific wavelength from signals of optical wavelength multiplex communication. Optimization purposes of the optical SAW filter are to maximize SAW intensity A_{L} on an optical signal path and to maximize a deviation amount ratio of the SAW intensity (SAW shift distance La/Lb) to the wavelength. Those optimization purposes are achieved by the SiO₂ layer arrangement.

FIG. 11 is a diagram illustrating a reference example of a flowchart of SiO₂ layer structural design based on the GA. As illustrated in FIG. 11, an arithmetic processing device generates a first-generation gene (step S110). Here, the arithmetic processing device divides the surface of the optical SAW filter into regions of a predetermined length, and encodes each of the regions using “1” for the SiO₂ layer and “0” for other than the SiO₂ layer.

The arithmetic processing device obtains a structure corresponding to the gene as an input value xₖₘ (S120). Here, k indicates a generation, and m indicates an input value number within the generation.

Then, the arithmetic processing device calculates an operation mode unique to each input value xₖₘ using a finite element method (FEM) or the like (S130). Here, the condition for solving the equation in which h(z) becomes zero is an eigensolution g(z). Since h(z) depends on a structure, it differs for each input value xₖₘ. Assuming that the range that can be the eigensolution is 1,000 points that z can take, the arithmetic processing device searches for the eigensolution and the unique operation mode for all of the 1,000 points. As a result, the arithmetic processing device determines the eigensolution and the unique operation mode. For example, the point z at which h(z) becomes zero is determined as the eigensolution g(z). The SAW intensity distribution as the unique operation mode is determined based on the eigensolution.

Then, the arithmetic processing device calculates performance based on the unique operation mode for the target input value (S140). For example, the arithmetic processing device calculates, as fitness, SAW intensity corresponding to the arrangement position of the optical signal path of each structure from the SAW intensity distribution for the input value of each structure. Here, when the input value is xₖ, f(xₖ) is calculated as the fitness. In addition, although illustration is omitted, the arithmetic processing device calculates the SAW shift distance (La/Lb) for the input value of each structure as the fitness.

Then, the arithmetic processing device evaluates the fitness corresponding to each input value (S150). Here, for example, the evaluation of the fitness in the SAW intensity is as follows. In a case of an input value x₁, the fitness is 1.0. In a case of an input value x₂, the fitness is 1.2. In a case of an input value x₃, the fitness is 1.4. In a case of an input value x₄, the fitness is 0.8. Accordingly, in this case, it is evaluated that fitness f(x) is the best when the width indicated by x is around “10”. Note that, in practice, the arithmetic processing device evaluates the fitness including the SAW shift distance.

Then, when a termination condition is not satisfied, the arithmetic processing device screens the input values based on the evaluation result (S160). Here, for example, the arithmetic processing device leaves the input value x₃ (=10), the input value x₁ (=6), and the input value x₂ (=8) with high fitness, and removes the input value x₄ (=12) with the lowest fitness.

Then, the arithmetic processing device generates an input value xₖ₊₁ₘ of the next generation (S170). For example, the arithmetic processing device mates the screened input values and mutates the mated input values, thereby generating the input value of the next generation. Then, the arithmetic processing device evaluates fitness for the input value of the next generation.

Then, when the termination condition is satisfied, the arithmetic processing device selects the optimum input value on the basis of the evaluation result (step S180).

The descriptions above refer to a case where the arithmetic processing device performs convergence calculation for all the points in the range that can be the eigensolution to obtain the eigensolution. The convergence calculation for obtaining the eigensolution involves a calculation cost. Accordingly, in order to reduce the calculation cost for obtaining the eigensolution, there has been disclosed a method in which an approximate eigensolution is predicted using a neural network (NN), convergence calculation for obtaining an accurate eigensolution from the approximate eigensolution is started, and a calculation range is narrowed down.

FIG. 12 is a diagram illustrating a reference example of the flowchart of the SiO₂ layer structural design based on the GA using NN prediction. As illustrated in FIG. 12, the arithmetic processing device generates a first-generation gene (step S210). Here, the arithmetic processing device divides the surface of the optical SAW filter into regions of a predetermined length, and encodes each of the regions using “1” for the SiO₂ layer and “0” for other than the SiO₂ layer.

The arithmetic processing device obtains a structure corresponding to the gene as an input value xₖₘ (S220). Here, k indicates a generation, and m indicates an input value number within the generation.

Then, the arithmetic processing device predicts an approximate eigensolution by the NN for each input value xₖₘ (step S230). For example, the arithmetic processing device estimates eigensolutions from the input values xₖₘ using the NN, and rounds each of the estimated eigensolutions to, for example, one of 20 kinds of quantified approximate eigensolutions. For example, the NN is a model that has trained individual input values and eigensolutions searched (full-range search) by performing convergence calculation for all the points in the range that can be the eigensolution for early genes (input values) of the 1st to 25th generations, which outputs the approximate eigensolution for the input value.

Then, the arithmetic processing device calculates an operation mode unique to each input value xₖₘ using the FEM or the like (S240). For example, the arithmetic processing device starts the convergence calculation for obtaining the accurate eigensolution from the approximate eigensolution predicted by the NN, and narrows down the calculation range. For example, the arithmetic processing device sequentially assigns a value of z within the range of the approximate eigensolution to the equation h(z), and obtains the value of z that becomes zero as the eigensolution. Note that, in a case where the arithmetic processing device fails to obtain the eigensolution based on the NN prediction, it performs searching (full-range search) for all the points in the range that can be the eigensolution by performing the convergence calculation to obtain the eigensolution. The SAW intensity distribution as the unique operation mode is determined based on the eigensolution.

Then, the arithmetic processing device calculates the performance based on the unique operation mode for the target input value (S250). For example, the arithmetic processing device calculates, as fitness, SAW intensity corresponding to the arrangement position of the optical signal path of each structure from the SAW intensity distribution for the input value of each structure. Here, in a case where the input value is xₖ, f(xₖ) is calculated as the fitness. In addition, although illustration is omitted, the arithmetic processing device calculates the SAW shift distance (La/Lb) for the input value of each structure as the fitness.

Then, the arithmetic processing device evaluates the fitness corresponding to each input value (S260).

Then, when the termination condition is not satisfied, the arithmetic processing device screens the input values based on the evaluation result (S270).

Then, the arithmetic processing device generates the input value xₖ₊₁ₘ of the next generation (S280). For example, the arithmetic processing device mates the screened input values and mutates the mated input values, thereby generating the input value of the next generation. Then, the arithmetic processing device evaluates fitness for the input value of the next generation.

Then, when the termination condition is satisfied, the arithmetic processing device selects the optimum input value on the basis of the evaluation result (step S290).

FIG. 13 is a reference example indicating a solution reached by the GA. As illustrated in FIG. 13, the X-axis represents the SAW intensity A_{L} on the optical signal path as one fitness, and the Y-axis represents wavelength dependence (La/Lb) of the SAW shift distance as one fitness. Here, in the method using the NN prediction, the quality of the eigensolution is equivalent to that in the method without the NN prediction, and thus the structure obtained by evolution is equivalent. For example, the Pareto solution (eigensolution) with two types of fitness does not differ regardless of whether the method uses the NN prediction or does not use the NN prediction.

FIG. 14 is a reference example indicating the total number of calculations of GA execution. In FIG. 14, a bar graph on the left indicates the total number of calculations needed to calculate the eigensolution by the method without the NN prediction. A bar graph on the right indicates the total number of calculations needed to calculate the eigensolution by the method using the NN prediction. According to the method using the NN prediction, it is possible to reduce the amount of calculation needed to calculate the eigensolution to ⅓ after the 26th generation.

Japanese Laid-open Patent Publication No. 2017-162069 and Tsunoda Yukito et al, “Neural-Network Assistance to Calculate Precise Eigenvalue for Fitness Evaluation of Real Product Design” are disclosed as related art.

### SUMMARY

According to an aspect of the embodiments, a non-transitory computer-readable recording medium storing an evolutionary computation program in which a processor included in a computer executes a process, the process includes: calculating fitness of a plurality of individuals based on a plurality of input in parallel in one generation; discontinuing, when a predetermined reference value at an end of a search for an eigensolution used to calculate the fitness of each of the plurality of individuals exceeds a threshold value, calculation of an individual in which the predetermined reference value exceeds the threshold value; and assigning an estimated fitness value to the individual for which the calculation is discontinued.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a functional block diagram illustrating a structure of an arithmetic processing device according to an embodiment;

FIG. 2A is a diagram for explaining cutoff timing control of an eigensolution search;

FIG. 2B is a diagram illustrating an evaluation result of the cutoff timing control of the eigensolution search;

FIG. 3 is a diagram illustrating an example of the cutoff timing control of the eigensolution search according to the embodiment;

FIG. 4A is a diagram (1) for explaining model generation according to the embodiment;

FIG. 4B is a diagram (2) for explaining the model generation according to the embodiment;

FIG. 4C is a diagram (3) for explaining the model generation according to the embodiment;

FIG. 5 is a diagram for explaining eigensolution prediction according to the embodiment;

FIG. 6 is a diagram illustrating an evaluation result of cutoff timing control according to the embodiment;

FIG. 7 is a diagram illustrating an exemplary flowchart of the model generation according to the embodiment;

FIG. 8 is a diagram illustrating an exemplary flowchart of structural design using a GA according to the embodiment;

FIG. 9 is a diagram illustrating an exemplary computer that executes an arithmetic processing program;

FIG. 10 is a diagram illustrating a reference example of optimum structure design for SiO₂ layer arrangement;

FIG. 11 is a diagram illustrating a reference example of a flowchart of SiO₂ layer structural design based on the GA;

FIG. 12 is a diagram illustrating a reference example of the flowchart of the SiO₂ layer structural design based on the GA using NN prediction;

FIG. 13 is a diagram illustrating a reference example indicating a solution reached by the GA;

FIG. 14 is a diagram illustrating a reference example indicating the total number of calculations of GA execution;

FIG. 15 is a diagram illustrating a reference example indicating a waiting time for the GA execution in a case of not using the NN prediction; and

FIG. 16 is a diagram illustrating a reference example indicating the waiting time for the GA execution in a case of using the NN prediction.

### DESCRIPTION OF EMBODIMENTS

Fitness calculation for each gene in each generation based on the GA is processed independently, whereby it is possible to perform parallel computing. In a case of applying parallelization to the fitness calculation for each gene in each generation based on the GA using the NN prediction, a time needed to complete the calculation differs depending on the gene.

Accordingly, there is a problem that the fitness evaluation in each generation may not be speeded up. For example, in a case where the fitness calculation for each individual in each generation is parallelized, it is not possible to shift to calculation of the next generation until the fitness calculation for all individuals is complete. For example, the calculation time for the fitness evaluation in each generation depends on the processing of the slowest individual in the generation.

For example, according to the GA using the NN prediction, the number of calculations and the calculation time of the fitness calculation for each individual vary depending on whether the NN prediction is correct or the prediction is incorrect. Accordingly, when there is an individual in which the prediction is incorrect, a waiting time at the time of parallelization may increase, and the calculation time for the fitness evaluation of this generation may not be speeded up. It can be said that the speed-up effect of the NN prediction is lowered.

In one aspect, it is an object of the embodiment to speed up calculation of fitness evaluation while maintaining variety of eigensolutions indispensable to fitness calculation at a time of performing parallel processing of the fitness calculation for each individual in evolutionary computation.

Hereinafter, an embodiment of an evolutionary computation program for parallel computing, an information processing apparatus, and an evolutionary computation method for parallel computing disclosed in the present application will be described in detail with reference to the drawings. Note that, in the embodiment, a case of obtaining, by evolutionary computation, optimum arrangement (structural design) of an optical signal path that maximizes SAW intensity on the optical signal path of an optical SAW filter and maximizes a deviation amount ratio of the SAW intensity (SAW shift distance) to a wavelength will be described. Furthermore, in the embodiment, the evolutionary computation will be described as a genetic algorithm (GA). However, the present disclosure is not limited to the embodiment.

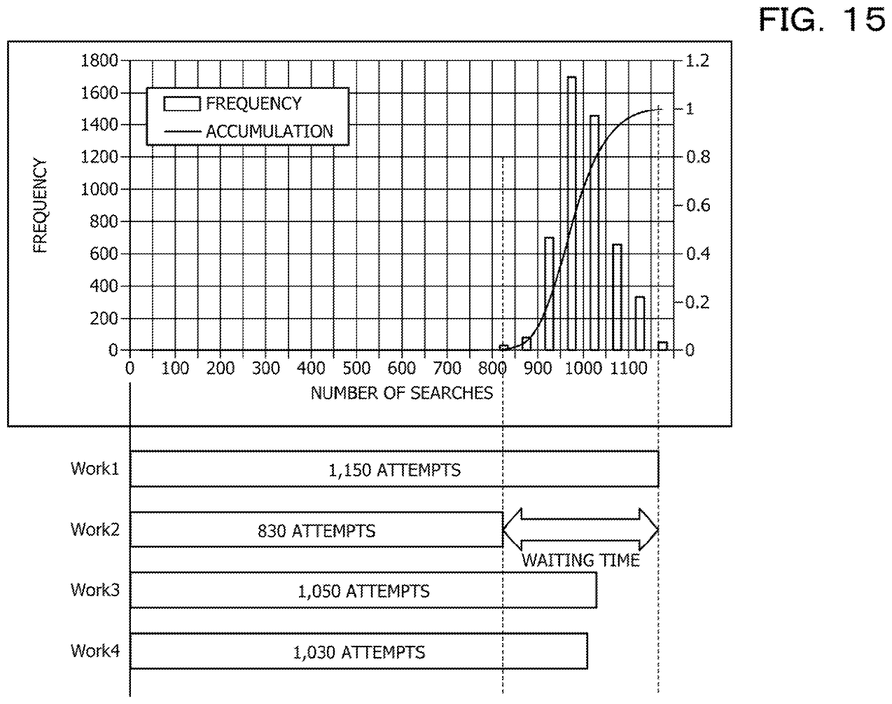

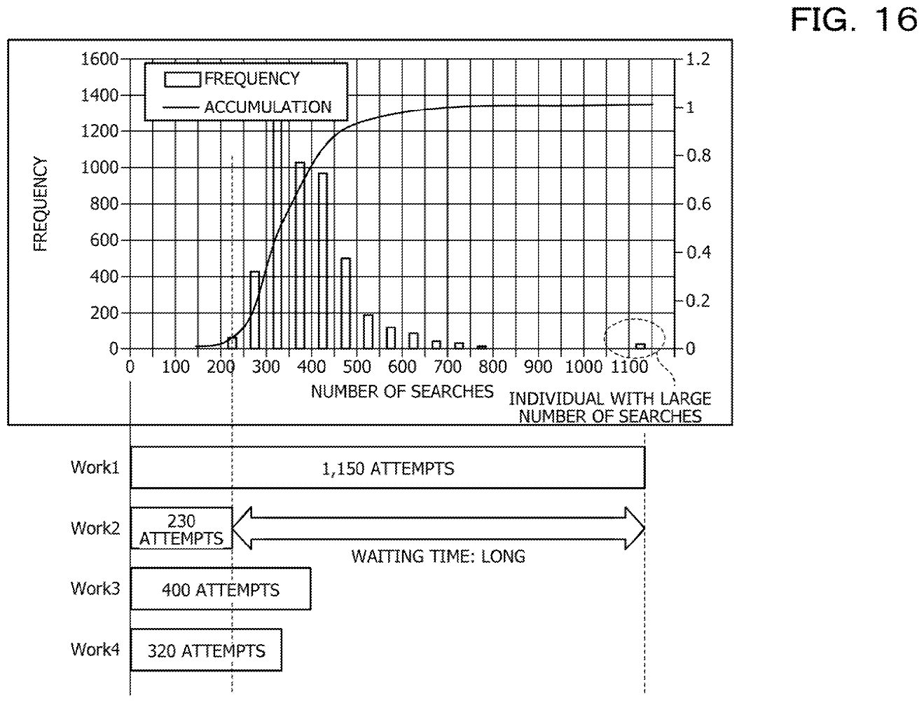

First, a waiting time at a time of performing parallel processing of fitness calculation for each individual based on the GA when neural network (NN) prediction is not used and when the NN prediction is used will be described with reference to FIGS. 15 and 16. The NN prediction referred to here indicates a method for an eigensolution search that predicts an approximate eigensolution using the NN and starts convergence calculation for obtaining an accurate eigensolution from the approximate eigensolution. In the NN prediction, in a case where acquisition of the eigensolution fails in a range of the approximate eigensolution, the eigensolution is obtained by performing the convergence calculation for all points in a range that can be the eigensolution. Performing the eigensolution search for all the points in the range that can be the eigensolution will be hereinafter referred to as a “full-range search”. Performing the eigensolution search for the range of the approximate eigensolution will be hereinafter referred to as a “partial range search”.

In a case of applying parallelization to the fitness calculation, a time needed to complete the calculation differs depending on the individual. Accordingly, when the fitness calculation for each individual in each generation is parallelized, it is not possible to shift to calculation of the next generation until the fitness calculation for all individuals is complete. For example, the calculation time for the fitness evaluation in each generation depends on the processing of the slowest individual.

FIG. 15 is a diagram illustrating a reference example indicating a waiting time for GA execution in a case of not using the NN prediction. The lower part of FIG. 15 illustrates the number of searches until eigensolution acquisition for each of a plurality of individuals. Note that a Work indicated in FIG. 15 refers to a device that performs arithmetic processing. For example, in a case of a multi-core CPU, there are as many Works as the number of cores. In a case of a multi-CPU arithmetic processing device, there are as many Works as the number of cores×the number of CPUs. In a case of a multi-node arithmetic processing device, there as many Works as the number of cores×the number of CPUs×the number of nodes.

According to the above, it can be seen that the number of searches needed to complete the calculation differs depending on the individual. Then, in a case where the fitness calculation is parallelized, it is not possible to shift to calculation of the next generation until the fitness calculation for all individuals is complete, whereby the waiting time from the earliest completion point of a Work 2 to the latest completion point of a Work 1 occurs. Furthermore, since the NN prediction is not used, the number of searches is concentrated between 800 and 1,200 as illustrated in the upper part of FIG. 15. Therefore, variations in the number of searches until the fitness is calculated for each individual are small, and the waiting time at the time of parallelization is shortened.

FIG. 16 is a diagram illustrating a reference example indicating the waiting time for the GA execution in a case of using the NN prediction. The lower part of FIG. 16 illustrates the number of searches until eigensolution acquisition for each of a plurality of individuals. According to the above, it can be seen that the number of searches needed to complete the calculation differs depending on the individual. For example, while only the partial range search is performed when the NN prediction is correct so that the number of searches is small, the entire range is searched when the prediction is incorrect so that the number of searches increases. Then, when the fitness calculation is parallelized, it is not possible to shift to calculation of the next generation until the fitness calculation for all individuals is complete, whereby the waiting time from the earliest completion point of a Work 2 to the latest completion point of a Work 1 occurs. According to the NN prediction, the number of searches until the fitness is calculated varies depending on whether the NN prediction is correct or the prediction is incorrect, whereby the waiting time at the time of parallelization becomes long. As illustrated in the upper part of FIG. 16, the number of searches peaks around 300, and varies between 200 and 1,200. Therefore, variations in the number of searches until the fitness is calculated for each individual are large, and the waiting time at the time of parallelization increases. For example, it can be said that the speed-up effect of the NN prediction is lowered.

Therefore, at the time of performing the parallel processing of the fitness calculation for each individual based on the GA, the fitness evaluation in each generation may not be speeded up.

In view of the above, the following embodiment describes an arithmetic processing device capable of speeding up the calculation of the fitness evaluation while maintaining variety of eigensolutions indispensable to the fitness calculation at a time of performing parallel processing of the fitness calculation for each individual based on the GA.

### Embodiment

[Structure of Information Processing Apparatus]

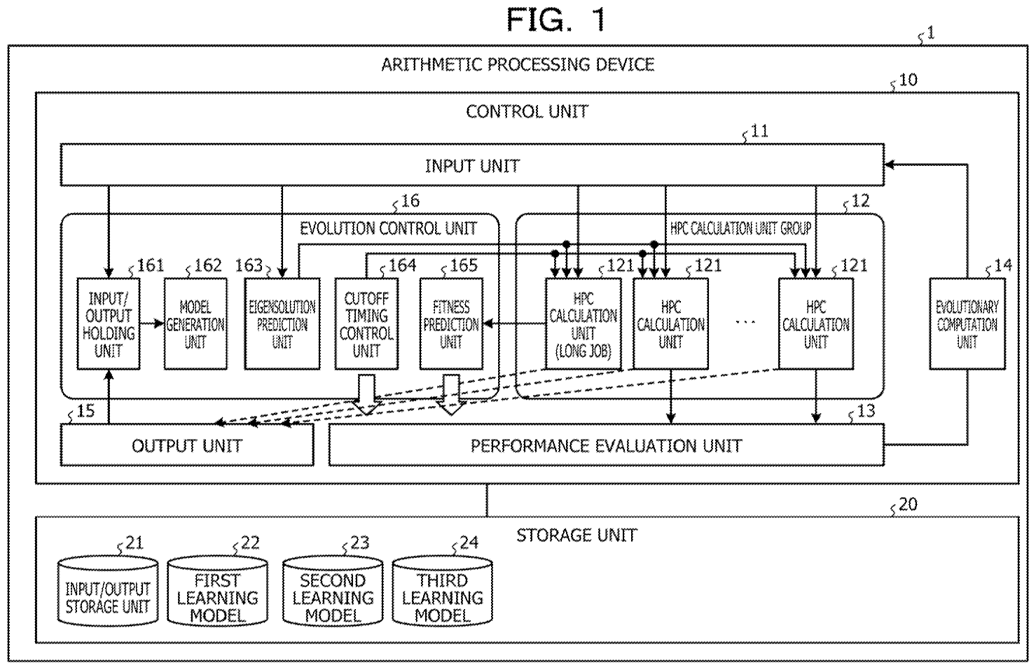

FIG. 1 is a functional block diagram illustrating a structure of an arithmetic processing device according to an embodiment. An arithmetic processing device 1 illustrated in FIG. 1 carries out the following process to reduce a waiting time caused by variation in a calculation time in evolutionary computation for calculating, by parallel processing, fitness of a plurality of individuals based on a plurality of inputs. The arithmetic processing device 1 assigns fitness leaned by an NN to an individual with a long calculation time in the generation currently in operation.

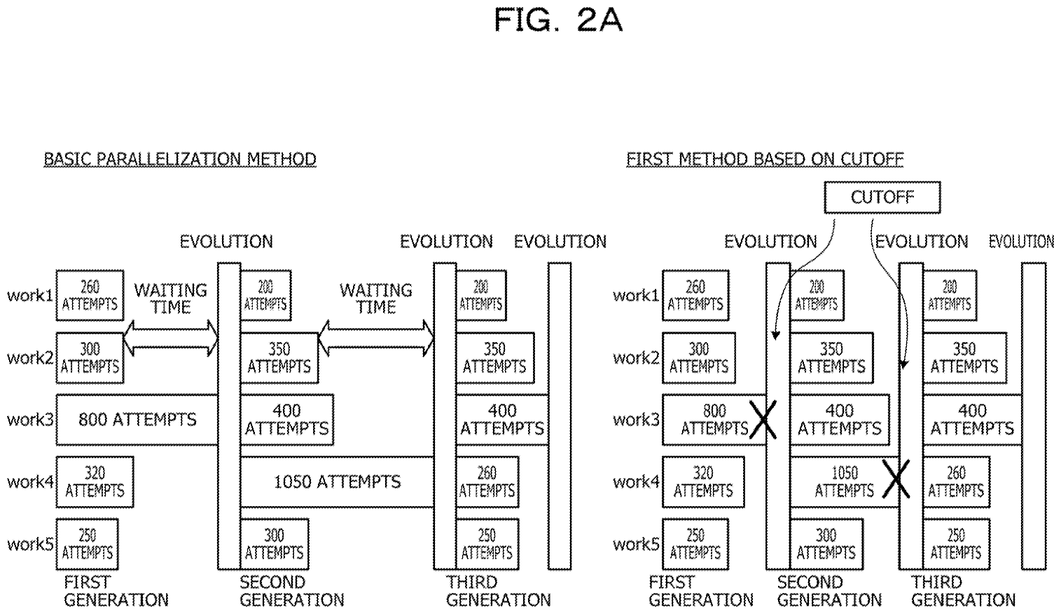

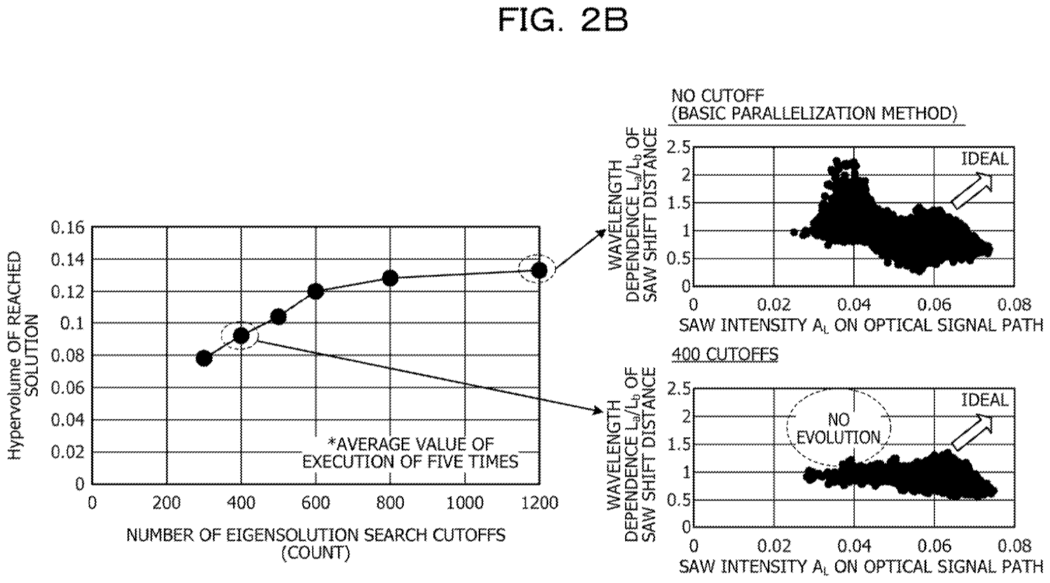

Here, it is conceivable to discontinue an eigensolution search of the individual with the long calculation time in the generation currently in operation to reduce the waiting time caused by the variation in the calculation time. In view of the above, cutoff timing control of the eigensolution search will be described with reference to FIGS. 2A and 2B. FIG. 2A is a diagram for explaining the cutoff timing control of the eigensolution search. FIG. 2B is a diagram illustrating an evaluation result of the cutoff timing control of the eigensolution search.

The left part of FIG. 2A illustrates the number of searches for the eigensolution search and the waiting time for each individual in a case of using NN prediction without the eigensolution search being discontinued. Here, in the first generation, the number of searches of a Work 3 is 800, which is the slowest, and in the second generation, the number of searches of a Work 4 is 1,050, which is the slowest. In a case of a GA using the NN prediction, it is known by experiments that the individuals with the number of searches exceeding 500, for example, are equal to or less than 10% of the total.

In view of the above, as illustrated in the right part of FIG. 2A, if a criterion for discontinuing the eigensolution search is set to, 500, for example, and the eigensolution search of individuals with the number exceeding 500 is discontinued to shift to the next generation, it becomes possible to reduce the waiting time for parallelization. It is sufficient if the arithmetic processing device evaluates the fitness of the discontinued individuals with the fitness as the lowest.

FIG. 2B illustrates a result of evaluating a relationship between the number of searches used as a criterion for discontinuation and quality of the eigensolution (reached solution) reached by the GA. The left part of FIG. 2B illustrates a graph in which the X-axis represents the number of cutoffs of the eigensolution search and the Y-axis represents a hypervolume of the reached solution. The right part of FIG. 2B illustrates solution distribution indicating a relationship of the quality of the eigensolution (reached solution) reached by the evolutionary computation when the X-axis represents SAW intensity A_{L} on an optical signal path as one fitness and the Y-axis represents wavelength dependence (La/Lb) of a SAW shift distance as one fitness. The upper right part of FIG. 2B illustrates solution distribution of a case without a cutoff of the eigensolution search. The lower right part of FIG. 2B illustrates solution distribution of a case where the number of cutoffs of the eigensolution search is 400. The hypervolume of the reached solution referred to here indicates an area calculated from the solution distribution.

As illustrated in the lower right part of FIG. 2B, when the number of cutoffs of the eigensolution search is 400, variety of reached solutions decreases. For example, while the evolution of the solution distribution in the right direction (direction along which A_{L} increases) is approximately equivalent to the case without the cutoff of the eigensolution search, the evolution of the solution distribution in the upward direction (direction along which La/Lb increases) is smaller than that of the case without the cutoff of the eigensolution search. For example, the variety of eigensolutions decreases. Then, as illustrated in the left part of FIG. 2B, when the number of cutoffs of the eigensolution search is 400, the quality (hypervolume) is lower than that of the case without the cutoff of the eigensolution search. This is estimated to be caused by suppression of the evolution in the range where the NN prediction is discontinued.

In view of the above, the arithmetic processing device 1 assigns the fitness trained by the NN to the individual with a long calculation time in the generation currently in operation to maintain the variety of eigensolutions, to reduce the waiting time caused by variation in the calculation time, and to speed up the calculation of the fitness evaluation.

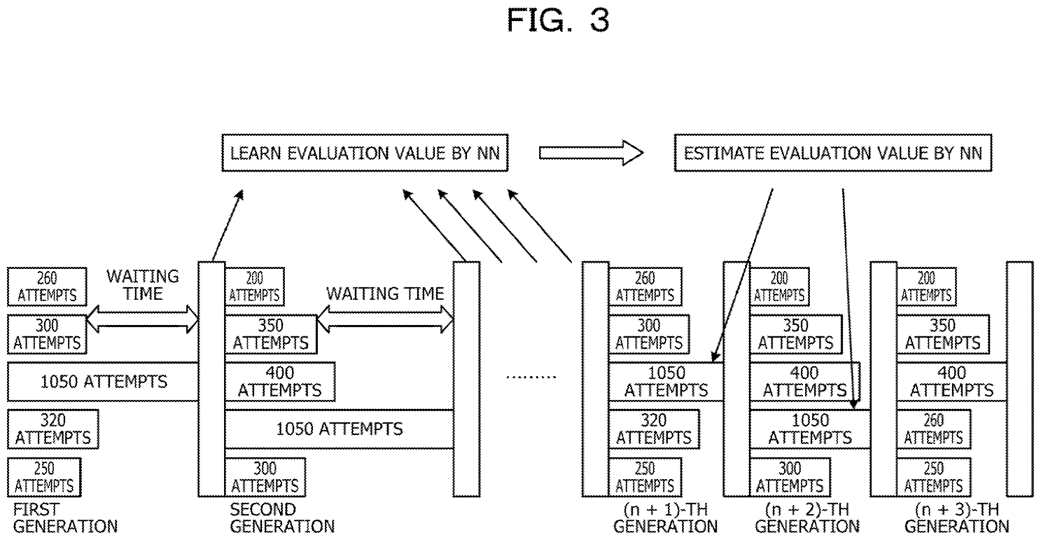

FIG. 3 is a diagram illustrating an example of the cutoff timing control of the eigensolution search according to the embodiment. As illustrated in FIG. 3, the arithmetic processing device 1 calculates an eigensolution for an individual for a plurality of generations, and calculates a fitness value from a fitness function (SAW intensity distribution) calculated on the basis of the eigensolution. Then, the arithmetic processing device 1 inputs the individual and the calculated fitness value to the NN to train the fitness.

Then, the arithmetic processing device 1 discontinues a search in a generation in operation for an individual with the number of searches of the eigensolution search exceeding a threshold value in the generation, and assigns a fitness value estimated by the NN to the discontinued individual. For example, when the threshold value is 500, the arithmetic processing device 1 discontinues the search for an individual with the number of searches exceeding 500, and assigns the trained fitness value estimated by the NN. Thereafter, the arithmetic processing device 1 evaluates the fitness corresponding to each individual in the generation in operation.

Returning to FIG. 1, the arithmetic processing device 1 includes a control unit 10 and a storage unit 20.

The control unit 10 corresponds to an electronic circuit such as a central processing unit (CPU). Then, the control unit 10 includes an internal memory for storing programs defining various processing procedures and control data, and executes a variety of types of processing using the programs and the control data. The control unit 10 includes an input unit 11, a high-performance computing (HPC) calculation unit group 12, a performance evaluation unit 13, an evolutionary computation unit 14, an output unit 15, and an evolution control unit 16.

The storage unit 20 is, for example, a semiconductor memory element such as a random access memory (RAM) or a flash memory, or a storage device such as a hard disk or an optical disk. The storage unit 20 includes an input/output storage unit 21, a first machine learning model 22, a second machine learning model 23, and a third machine learning model 24.

The input/output storage unit 21 stores past input values, output values (fitness), and eigensolutions in association with each other. Note that the input/output storage unit 21 is stored by an input/output holding unit 161 to be described later. The input value referred to here indicates a structure corresponding to a gene. The gene refer to here is a gene in which each of regions obtained by dividing the surface of an optical SAW filter into the regions of a predetermined length is encoded with “1” for a 902 layer and “0” for other than the SiO₂ layer. The fitness referred to here indicates the SAW intensity on the optical signal path for the input value and the value of the wavelength dependence (La/Lb) of the SAW shift distance.

The first machine learning model 22 is a model as a result of carrying out training to obtain a value range of the eigensolution corresponding to a new input value using a past input value and the eigensolution corresponding to the input value. The first machine learning model 22 is trained by, for example, a method using a neural network (NN). Note that the first machine learning model 22 is generated by a model generation unit 162 to be described later.

The second machine learning model 23 is a model as a result of carrying out training to obtain the SAW intensity corresponding to a new input value using a past input value and the SAW intensity on the optical signal path corresponding to the input value. The second machine learning model 23 is trained by, for example, a method using a neural network (NN). Note that the second machine learning model 23 is generated by the model generation unit 162 to be described later.

The third machine learning model 24 is a model as a result of carrying out training to obtain a value of the wavelength dependence (La/Lb) of the SAW shift distance corresponding to a new input value using a past input value and the value of the wavelength dependence (La/Lb) of the SAW shift distance corresponding to the input value. The third machine learning model 24 is trained by, for example, a method using a neural network (NN). Note that the third machine learning model 24 is generated by the model generation unit 162 to be described later.

The input unit 11 outputs, to an HPC calculation unit 121 and to the input/output holding unit 161 to be described later, the input value to be designed used to generate the first machine learning model 22, the second machine learning model 23, and the third machine learning model 24. Furthermore, the input unit 11 outputs, to an eigensolution prediction unit 163 to be described later, the input value to be designed used to predict the eigensolution using the first machine learning model 22.

The HPC calculation unit group 12 includes a plurality of the HPC calculation units 121. Hereinafter, one HPC calculation unit 121 will be described.

The HPC calculation unit 121 inputs an input value to be designed of a predetermined generation to obtain an eigensolution that satisfies the eigensolution condition for the input value. For example, the HPC calculation unit 121 searches for an eigensolution that satisfies the eigensolution condition for the input value from the entire range that can be the eigensolution. For example, in a case where the function for obtaining Aₙ is expressed as h(z) when A₁=1 and B₁=0 of the eigensolution condition of the formula (2) are input, the HPC calculation unit 121 solves the equation where Aₙ, which is h(z), becomes zero from the condition of Aₙ=0. The condition for solving the equation that becomes zero is an eigensolution g(z). Since the range that can be the eigensolution is all the points that may be taken by z, the HPC calculation unit 121 searches for an eigensolution in which h(z) becomes zero for all the points that may be taken by z. For example, the HPC calculation unit 121 performs a full-range search for all the points that may be taken by z. Then, the HPC calculation unit 121 outputs the eigensolution for the input value searched by the full-range search to the output unit 15 to be described later.

In addition, the HPC calculation unit 121 calculates SAW intensity distribution (unique operation) as an objective function on the basis of the eigensolution. For example, the HPC calculation unit 121 calculates SAW intensity distribution corresponding to the eigensolution on the basis of the formula (1). Here, the HPC calculation unit 121 substitutes the eigensolution for Neff in the formula (1), and calculates the SAW intensity distribution corresponding to the eigensolution. The HPC calculation unit 121 calculates SAW intensity for the input value as one fitness using the SAW intensity distribution for the input value. In addition, the HPC calculation unit 121 calculates, as one fitness, a value of the wavelength dependence (La/Lb) of the SAW shift distance for the input value. Then, the HPC calculation unit 121 outputs the fitness for the input value to the performance evaluation unit 13 and the output unit 15 to be described later.

Here, when the HPC calculation unit 121 receives notification of cutoff timing from a cutoff timing control unit 164 to be described later when the calculation of the eigensolution search is not complete, it discontinues the eigensolution search. Then, the HPC calculation unit 121 requests a fitness prediction unit 165 to be described later to predict fitness. For example, the HPC calculation unit 121 discontinues the search for the individual whose cutoff timing has come in the generation in operation, and requests the fitness prediction unit 165 to predict the fitness of the individual to be discontinued.

The performance evaluation unit 13 evaluates performance of each input value on the basis of the fitness for each input value. For example, when the performance evaluation unit 13 receives the notification of the cutoff timing from the cutoff timing control unit 164 to be described later, it evaluates the performance of each input value using the fitness for each input value output from the HPC calculation unit 121 and the fitness for each input value predicted by the fitness prediction unit 165 to be described later. For example, the performance evaluation unit 13 evaluates the performance result using the input value for which the eigensolution search is complete and the input value for which the eigensolution search is not complete but the fitness is predicted. Then, the performance evaluation unit 13 screens fitting input values, which are input values to be left, from the plurality of input values on the basis of the performance evaluation result of each input value.

The evolutionary computation unit 14 mates the screened input values and mutates the mated input values, thereby generating the input value of the next generation. Then, the evolutionary computation unit 14 outputs the input value of the next generation to the input unit 11.

The output unit 15 outputs, to the input/output holding unit 161 to be described later, the eigensolution and the fitness for the input value output from the HPC calculation unit 121 and searched by the full-range search.

The evolution control unit 16 includes the input/output holding unit 161, the model generation unit 162, the eigensolution prediction unit 163, the cutoff timing control unit 164, and the fitness prediction unit 165.

The input/output holding unit 161 retains, in the input/output storage unit 21, the eigensolution and the fitness for each of the input values searched by the full-range search.

The model generation unit 162 generates the first machine learning model 22 for predicting in which value range the eigensolution that satisfies the eigensolution condition for a new input value is located based on the eigensolution for the input value searched by the full-range search. For example, the model generation unit 162 causes the neural network (NN) to train the individual input values and eigensolutions stored in the input/output storage unit 21 and searched by the full-range search, thereby generating the first machine learning model 22 for predicting the value range of the eigensolution for the new input value. Note that it is sufficient if the model generation unit 162 generates the first machine learning model 22 using the eigensolutions for the input values from the first generation to the m-th generation. The m-th generation is, for example, the 25th generation.

Furthermore, the model generation unit 162 generates the second machine learning model 23 for predicting SAW intensity for a new input value based on the SAW intensity as one fitness for the input value. For example, the model generation unit 162 causes the NN to train each input value and SAW intensity stored in the input/output storage unit 21, thereby generating the second machine learning model 23 for predicting the SAW intensity for the new input value. Note that it is sufficient if the model generation unit 162 generates the second machine learning model 23 using the SAW intensity as one fitness for the input values from the first generation to the m-th generation. The m-th generation is, for example, the 25th generation.

Furthermore, the model generation unit 162 generates the third machine learning model 24 for predicting a value of the wavelength dependence (La/Lb) of the SAW shift distance for a new input value based on the value of the wavelength dependence (La/Lb) of the SAW shift distance as one fitness for the input value. For example, the model generation unit 162 causes the NN to train each input value and value of the wavelength dependence (La/Lb) of the SAW shift distance stored in the input/output storage unit 21, thereby generating the third machine learning model 24 for predicting the value of the wavelength dependence (La/Lb) of the SAW shift distance for the new input value. Note that it is sufficient if the model generation unit 162 generates the third machine learning model 24 using the value of the wavelength dependence (La/Lb) of the SAW shift distance as one fitness for the input values from the first generation to the m-th generation. The m-th generation is, for example, the 25th generation.

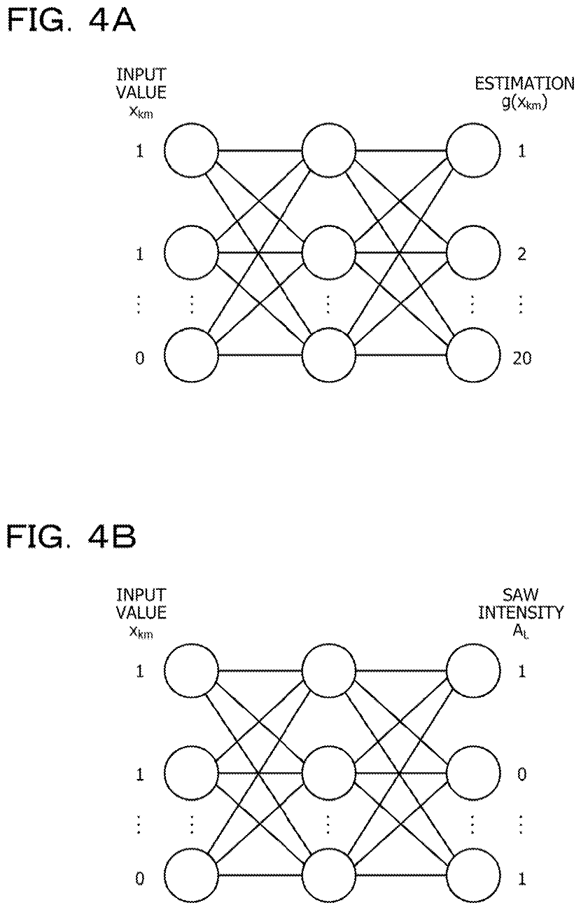

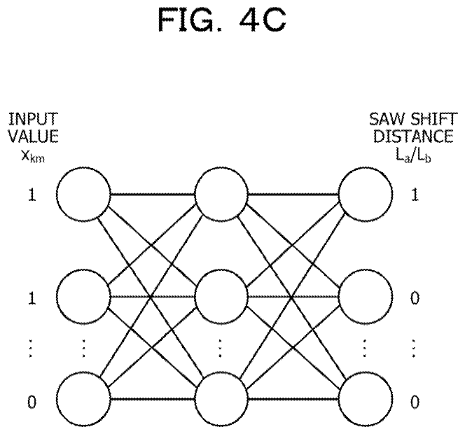

Here, the model generation by the model generation unit 162 will be described with reference to FIGS. 4A, 4B, and 4C. FIGS. 4A to 4C are diagrams for explaining the model generation according to the embodiment. A target model to be subject to the model generation illustrated in FIG. 4A is a machine learning model for predicting an eigensolution. A target model to be subject to the model generation illustrated in FIG. 4B is a machine learning model for predicting SAW intensity as one fitness. A target model to be subject to the model generation illustrated in FIG. 4C is a machine learning model for predicting a wavelength dependence (La/Lb) of a SAW shift distance as one fitness.

As illustrated in FIG. 4A, the model generation unit 162 causes the NN to train an input value xₖₘ and an eigensolution g(xₖₘ), thereby generating the first machine learning model 22 for predicting estimated g(xₖₘ) for the input value. The estimated g(xₖₘ) referred to here indicates a value range of the eigensolution. Furthermore, k indicates a generation, and m indicates an input value within the generation.

As illustrated in FIG. 4B, the model generation unit 162 causes the NN to train the input value xₖₘ and the SAW intensity as one fitness, thereby generating the second machine learning model 23 for predicting the SAW intensity for the input value.

As illustrated in FIG. 4C, the model generation unit 162 causes the NN to train the input value xₖₘ and the SAW shift distance La/Lb as one fitness, thereby generating the third machine learning model 24 for predicting the SAW shift distance La/Lb for the input value.

Returning to FIG. 1, the eigensolution prediction unit 163 predicts in which value range (solution candidate value range) the eigensolution for the input value is located using the first machine learning model 22. Then, the eigensolution prediction unit 163 searches for an eigensolution for the input value that satisfies the eigensolution condition for the input value within the range of the predicted eigensolution value range.

For example, when the function for obtaining Aₙ is expressed as h(z) when A₁=1 and B₁=0 of the eigensolution condition of the formula (2) are input, the eigensolution prediction unit 163 solves the equation where Aₙ, which is h(z), becomes zero from the condition of Aₙ=0. The condition for solving the equation that becomes zero is an eigensolution g(z). Here, the range of z for solving the equation that becomes zero is the range (partial range) of the predicted eigensolution value range. The eigensolution prediction unit 163 searches for an eigensolution for points within the range of the predicted eigensolution value range to predict the eigensolution. For example, the eigensolution prediction unit 163 carries out the partial range search for searching the points within the range of the predicted eigensolution value range. For example, the eigensolution prediction unit 163 sequentially assigns the value of z within the range of the eigensolution value range to the equation h(z), and predicts the value of z that becomes zero as the eigensolution.

Then, when the prediction of the eigensolution has succeeded, the eigensolution prediction unit 163 outputs the eigensolution to the HPC calculation unit 121 together with the input value. This is to cause the HPC calculation unit 121 to calculate the SAW intensity distribution (unique operation) of the eigensolution for the input value and calculate the fitness for the input value. On the other hand, when the prediction of the eigensolution has failed, the eigensolution prediction unit 163 outputs the input value for the eigensolution failed in the prediction to the HPC calculation unit 121. This is to cause the HPC calculation unit 121 to obtain the eigensolution for the input value by the full-range search.

[Description of Eigensolution Prediction]

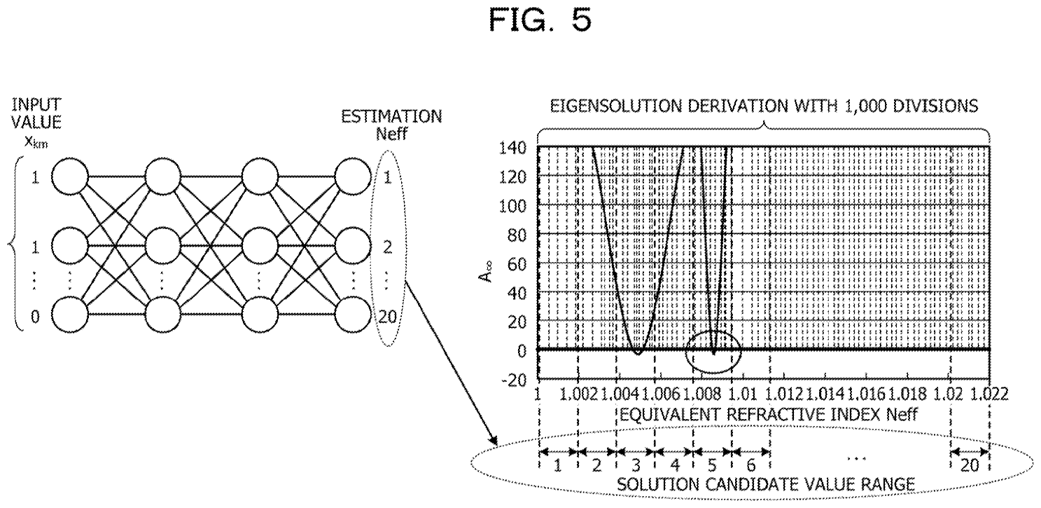

Here, the eigensolution prediction by the eigensolution prediction unit 163 will be described with reference to FIG. 5. FIG. 5 is a diagram for explaining the eigensolution prediction according to the first embodiment. Note that, in FIG. 5, the solution candidate value range is divided into 20 value ranges of 50 points obtained by dividing 1,000 points into 20 in advance.

First, the eigensolution prediction unit 163 predicts a solution candidate value range for the input value xₖₘ using the first machine learning model 22 illustrated in the left part of FIG. 5.

Next, as illustrated in the right part of FIG. 5, the eigensolution prediction unit 163 searches for an eigensolution for the input value that satisfies the eigensolution condition for the input value within the range of the predicted solution candidate value range. Here, it is assumed that the predicted solution candidate value range is “5”. Then, the eigensolution prediction unit 163 solves the equation in which the function h(z) for obtaining Aₙ when A₁=1 and B₁=0 of the eigensolution condition of the formula (2) are input becomes zero from the condition of Aₙ=0 within the range where the solution candidate value range indicates “5”. For example, the eigensolution prediction unit 163 assigns the value of z within the range where the solution candidate value range indicates “5” to the equation h(z). When the function h(z) becomes zero at any z value within the range of the solution candidate value range, which is, when the eigensolution prediction has succeeded, the eigensolution prediction unit 163 predicts the value of z at which the function h(z) becomes zero as an eigensolution. As a result, the eigensolution prediction unit 163 only needs to search the range of 1/20 as compared with the case of the full-range search that searches all the points in the range that may be the solution, whereby it becomes possible to reduce the amount of calculation to 1/20, and to increase the speed.

Note that, when the function h(z) does not become zero at the value of z within the range of the solution candidate value range, which is, when the eigensolution prediction has failed, the eigensolution prediction unit 163 only needs to cause the HPC calculation unit 121 to obtain the eigensolution by the full-range search.

The cutoff timing control unit 164 controls the timing at which the eigensolution search for a plurality of input values calculated by the plurality of HPC calculation units 121 is discontinued. For example, the cutoff timing control unit 164 monitors the number of searches of the eigensolution search for each of the plurality of input values in a generation, and when the number of searches for any input value of the plurality of input values exceeds a threshold value, it discontinues the eigensolution search for the input value with the number of searches exceeding the threshold value. Then, the cutoff timing control unit 164 notifies the HPC calculation unit 121 performing the eigensolution search for the discontinued input value of the fact that the cutoff timing is reached. Furthermore, the cutoff timing control unit 164 notifies the performance evaluation unit 13 of the fact that the cutoff timing is reached. For example, it can be said that the cutoff timing control unit 164 controls the timing of evolution.

Note that, although the cutoff timing control unit 164 has been described to control the timing at which the eigensolution search is discontinued based on the number of searches of the eigensolution search, it is not limited to this. The cutoff timing control unit 164 may control the timing at which the eigensolution search is discontinued based on the calculation time of the eigensolution search instead of the number of searches of the eigensolution search. Furthermore, the cutoff timing control unit 164 may control the timing at which the eigensolution search is discontinued based on the number of individuals (number of input values) for which the eigensolution search is complete. Furthermore, the cutoff timing control unit 164 may control the timing at which the eigensolution search is discontinued based on the ratio of the number of running HPC calculation units 121 that have completed the eigensolution search.

The fitness prediction unit 165 predicts the fitness of the individuals for which the eigensolution search is discontinued. For example, upon reception of a prediction request from the HPC calculation unit 121, the fitness prediction unit 165 predicts the fitness for the input value for which the HPC calculation unit 121, from which the prediction request has been received, has been in charge of calculation. As an example, the fitness prediction unit 165 predicts the SAW intensity for the corresponding input value using the second machine learning model 23. In addition, the fitness prediction unit 165 predicts the SAW shift distance La/Lb for the corresponding input value using the third machine learning model 24. Then, the fitness prediction unit 165 outputs, to the performance evaluation unit 13, the predicted fitness for the corresponding input value.

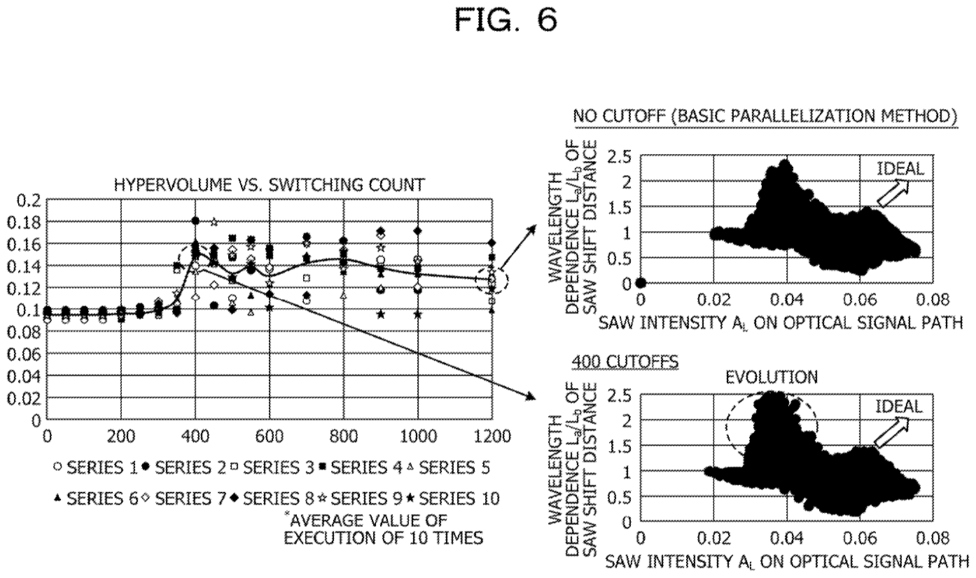

FIG. 6 is a diagram illustrating an evaluation result of the cutoff timing control according to the embodiment.

The left part of FIG. 6 illustrates a graph representing an average value in a case where a series is changed and executed 10 times when the X-axis represents the number of cutoffs of the eigensolution search and the Y-axis represents a hypervolume of the eigensolution (reached solution) reached by the evolutionary computation. The series in the left part of FIG. 6 indicates a pattern of random numbers when mating, mutation, and selection are performed in the evolutionary computation. Here, it is a case where it is carried out with 10 patterns of random numbers of series 1 to series 10.

The right part of FIG. 6 illustrates solution distribution indicating a relationship of the quality of the eigensolution (reached solution) reached by the evolutionary computation when the X-axis represents the SAW intensity A_{L} on the optical signal path as one fitness and the Y-axis represents the wavelength dependence (La/Lb) of the SAW shift distance as one fitness. The upper right part of FIG. 6 illustrates solution distribution of a case without a cutoff of the eigensolution search. The lower right part of FIG. 6 illustrates solution distribution of a case where the number of cutoffs of the eigensolution search is 400. The hypervolume of the reached solution referred to here indicates an evaluation scale of the solution distribution, which refers to an area calculated from the solution distribution.

As illustrated in the left part of FIG. 6, even when the number of cutoffs of the eigensolution search is 400, the hypervolume of the achievement degree approximately similar to that of the case where the number of cutoffs of the eigensolution search is 1,200 is indicated. Moreover, as illustrated in the right part of FIG. 6, even when the number of cutoffs of the eigensolution search is 400, the variety of the reached solutions is maintained as compared with the case with no number of cutoffs of the eigensolution search. For example, when the cutoff timing control according to the embodiment is performed, the evolution of the solution distribution in the upward direction (direction along which La/Lb increases) as illustrated in the lower right part of FIG. 2B is not suppressed and is maintained as compared with the case without the cutoff of the eigensolution search. This is estimated to be caused by the fact that the individuals with a large number of searches are not removed and are used for the evolution with high probability even though they are predicted values including errors. As a result, it is estimated that the quality (hypervolume) may be maintained.

[Flowchart of Model Generation]

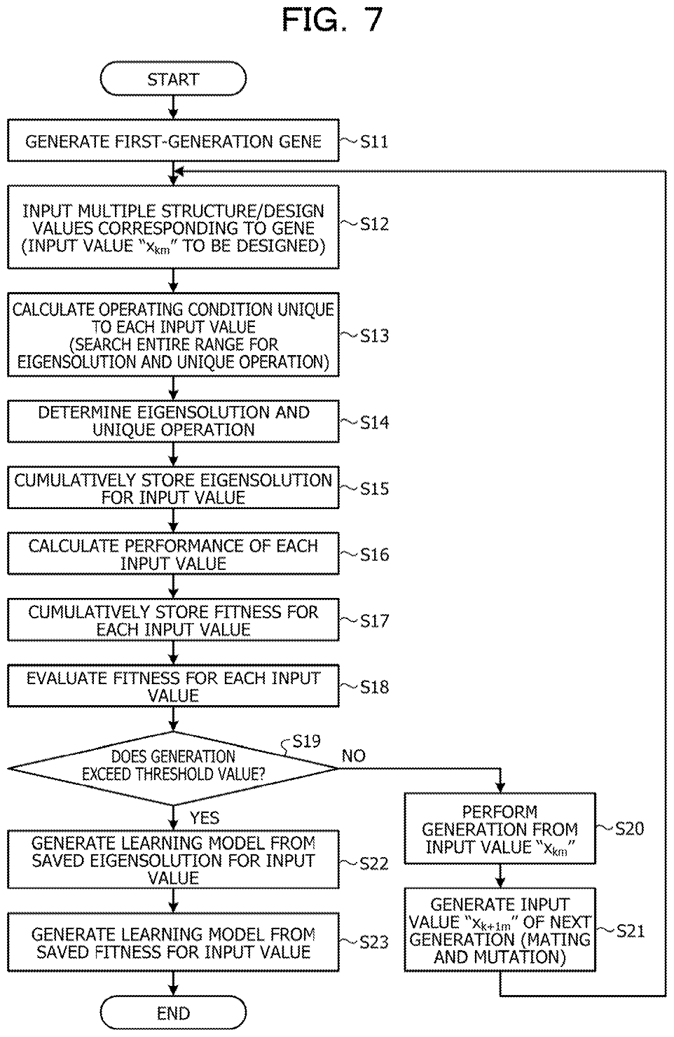

FIG. 7 is a diagram illustrating an exemplary flowchart of the model generation according to the embodiment. Note that an initial value of a generation k is assumed to be “1”.

As illustrated in FIG. 7, the input unit 11 generates a first-generation gene (step S11). Here, the input unit 11 divides the surface of the optical SAW filter into regions of a predetermined length, and encodes each of the regions using “1” for the SiO₂ layer and “0” for other than the SiO₂ layer.

The input unit 11 inputs a plurality of structure/design values corresponding to the gene as input values xₖₘ (step S12). Here, k indicates a generation, and m indicates an input value number within the generation.

The HPC calculation unit 121 calculates an operating condition unique to each input value “xₖₘ” (step S13). For example, the HPC calculation unit 121 calculates, for each input value, a function h(z) for obtaining Aₙ when A₁=1 and B₁=0 of the eigensolution condition of the formula (2) are input. Then, the HPC calculation unit 121 solves, for each input value, the equation in which Aₙ, which is h(z), becomes zero for all the points that may be taken by z from the condition of Aₙ=0 of the eigensolution condition of the formula (2).

The HPC calculation unit 121 determines an eigensolution and a unique operation for each input value (step S14). For example, the HPC calculation unit 121 determines, for each input value, the value of z that becomes zero as a result of solving the equation h(z) as an eigensolution. Then, the HPC calculation unit 121 calculates, as a unique operation, SAW intensity distribution corresponding to the determined eigensolution based on the formula (1). Here, the HPC calculation unit 121 substitutes the eigensolution for Neff in the formula (1), and calculates the SAW intensity distribution corresponding to the eigensolution.

Then, the input/output holding unit 161 cumulatively stores the eigensolutions for the input values in the input/output storage unit 21 (step S15).

Then, the HPC calculation unit 121 calculates performance of each input value (step S16). For example, the HPC calculation unit 121 calculates, as one fitness, SAW intensity corresponding to the arrangement position of the optical signal path of each structure indicated by the input value from the SAW intensity distribution corresponding to the input value. In addition, the HPC calculation unit 121 calculates, as one fitness, a value of the wavelength dependence (La/Lb) of the SAW shift distance for the input value.

Then, the performance evaluation unit 13 cumulatively stores the fitness for the input values (step S17).

Then, the performance evaluation unit 13 evaluates the performance of each input value on the basis of the fitness for each input value (step S18).

Then, the performance evaluation unit 13 determines whether or not the current generation exceeds a threshold value (step S19). When it is determined that the current generation does not exceed the threshold value (No in step S19), the evolutionary computation unit 14 screens the input values from the current input values “xₖₘ” based on the evaluation result (step S20).

Then, the evolutionary computation unit 14 generates an input value “xₖ₊₁ₘ” of the next generation (step S21). For example, the evolutionary computation unit 14 mates the screened input values and mutates the mated input values, thereby generating the input value of the next generation. Then, the evolutionary computation unit 14 proceeds to step S12 to process the next generation.

On the other hand, when it is determined that the current generation exceeds the threshold value (Yes in step S19), the model generation unit 162 generates, from the saved eigensolution for the input value, the first machine learning model 22 for predicting in which value range the eigensolution for a new input value is located (step S22).

Then, the model generation unit 162 generates, from the saved fitness for the input value, the second machine learning model 23 and the third machine learning model 24 for predicting fitness for the new input value (step S23). For example, the model generation unit 162 generates the second machine learning model 23 for predicting the SAW intensity for the new input value from the saved SAW intensity for the input value. In addition, the model generation unit 162 generates the third machine learning model 24 for predicting the value of the wavelength dependence (La/Lb) of the SAW shift distance for the new input value from the saved value of the wavelength dependence (La/Lb) of the SAW shift distance for the input value. Then, the model generation process is terminated.

[Flowchart of Structural Design Using GA]

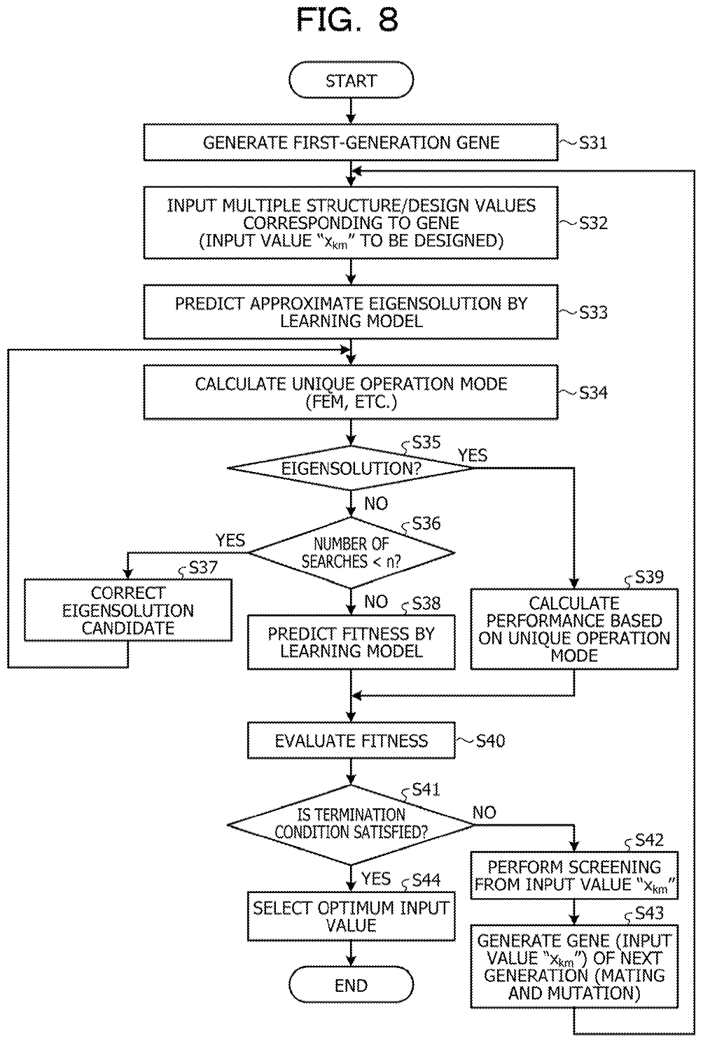

FIG. 8 is a diagram illustrating an exemplary flowchart of the structural design using the GA according to the embodiment. Note that an initial value of a generation k is assumed to be a value obtained by adding one to the threshold value used in the model generation.

As illustrated in FIG. 8, the input unit 11 generates a first-generation gene (step S31). Here, the input unit 11 divides the surface of the optical SAW filter into regions of a predetermined length, and encodes each of the regions using “1” for the SiO₂ layer and “0” for other than the SiO₂ layer. Then, the input unit 11 inputs a plurality of input values “xₖₘ” (structure/design values) to be designed (step S32).

The eigensolution prediction unit 163 predicts an approximate eigensolution by the first machine learning model 22 (step S33). For example, the eigensolution prediction unit 163 predicts in which value range (solution candidate value range) the eigensolution for the input value is located using the first machine learning model 22.

The eigensolution prediction unit 163 calculates an operation mode unique to each input value xₖₘ using a finite element method (FEM) or the like (S34). For example, in a case where the function for obtaining Aₙ is expressed as h(z) when A₁=1 and B₁=0 of the eigensolution condition of the formula (2) are input, the eigensolution prediction unit 163 solves the equation where Aₙ, which is h(z), becomes zero from the condition of Aₙ=0. The range of z for solving the equation that becomes zero is the range (partial range) of the predicted eigensolution value range. The eigensolution prediction unit 163 searches for an eigensolution for points within the range of the predicted eigensolution value range.

Then, the eigensolution prediction unit 163 determines whether or not the eigensolution search has succeeded (step S35). When it is determined that it is not possible to search the eigensolution (No in step S35), the cutoff timing control unit 164 determines whether or not the number of searches is less than n using the number of searches as cutoff timing (step S36). Note that the cutoff timing control unit 164 may use the calculation time of the first generation as the cutoff timing instead of the number of searches. Furthermore, the cutoff timing control unit 164 may use the number of individuals (number of input values) for which the eigensolution search is complete as the cutoff timing instead of the number of searches. Furthermore, the cutoff timing control unit 164 may use the ratio of the number of the HPC calculation units 121 that have completed the search as the cutoff timing instead of the number of searches.

If it is determined that the number of searches is less than n (Yes in step S36), the HPC calculation unit 121 corrects z indicating the eigensolution candidate (step S37). Then, the HPC calculation unit 121 proceeds to step S34 to solve the equation in which h(z) becomes zero for z indicating the eigensolution candidate.

On the other hand, When it is determined that the number of searches is equal to or more than n (No in step S36), the cutoff timing control unit 164 discontinues the eigensolution search for the input value. Then, the fitness prediction unit 165 predicts the fitness based on the second machine learning model 23 and the third machine learning model 24 (step S38). For example, the fitness prediction unit 165 predicts the SAW intensity for the input value using the second machine learning model 23. In addition, the fitness prediction unit 165 predicts the value of the SAW shift distance La/Lb for the input value using the third machine learning model 24. Then, the fitness prediction unit 165 proceeds to step S40 to evaluate the fitness.

On the other hand, when it is determined that the eigensolution search has succeeded (Yes in step S35), the HPC calculation unit 121 calculates performance based on the unique operation mode (step S39). For example, the HPC calculation unit 121 calculates SAW intensity distribution corresponding to the eigensolution on the basis of the formula (1). The HPC calculation unit 121 calculates SAW intensity for the input value as one fitness using the SAW intensity distribution for the input value. In addition, the HPC calculation unit 121 calculates, as one fitness, a value of the wavelength dependence (La/Lb) of the SAW shift distance for the input value. Then, the HPC calculation unit 121 proceeds to step S40 to evaluate the fitness.

In step S40, the performance evaluation unit 13 evaluates the performance of each input value on the basis of the fitness for each input value (step S40).

Then, the performance evaluation unit 13 determines whether or not a termination condition is satisfied (step S41). When it is determined that the termination condition is not satisfied (No in step S41), the evolutionary computation unit 14 screens the input values from the current input values “xₖₘ” based on the evaluation result (step S42).

Then, the evolutionary computation unit 14 generates an input value “xₖ₊₁ₘ” of the next generation (step S43). For example, the evolutionary computation unit 14 mates the screened input values and mutates the mated input values, thereby generating the input value of the next generation. Then, the evolutionary computation unit 14 proceeds to step S32 to process the next generation.

On the other hand, when it is determined that the termination condition is satisfied (Yes in step S41), the performance evaluation unit 13 selects the optimum input value on the basis of the performance evaluation result of each input value (step S44). Then, the process of the GA is terminated.

### Effects of Embodiment

According to the embodiment described above, the arithmetic processing device 1 carries out the fitness calculation of a plurality of individuals in parallel in one generation in the evolutionary computation of calculating fitness of a plurality of individuals based on a plurality of inputs by parallel processing. In a case where a predetermined reference value at the end of the search for the eigensolution used to calculate the fitness of each individual exceeds a threshold value, the arithmetic processing device 1 discontinues the calculation of the individual. The arithmetic processing device 1 assigns an estimated fitness value to the individual in which the calculation is discontinued. According to such a configuration, the arithmetic processing device 1 is enabled to speed up the calculation of the fitness evaluation while maintaining the variety of eigensolutions used for the fitness calculation at the time of performing the parallel processing of the fitness calculation for each individual in the evolutionary computation. For example, the arithmetic processing device 1 is enabled to reduce the waiting time caused by the variation in the calculation time of the search for the eigensolution used to calculate the fitness of each individual.

Furthermore, the arithmetic processing device 1 calculates a first eigensolution for an individual based on a first input, and calculates a first fitness value from a fitness function calculated based on the first eigensolution. The arithmetic processing device 1 generates the second machine learning model 23 and the third machine learning model 24 for estimating the fitness based on the first input and the calculated first fitness value. When a predetermined reference value at the end of the search for the eigensolution for the individual based on a second input exceeds a threshold value, the arithmetic processing device 1 discontinues the calculation of the individual based on the second input. Then, the arithmetic processing device 1 estimates a fitness value for the individual for which the calculation is discontinued using the generated second machine learning model 23 and the third machine learning model 24, and assigns the estimated fitness value to the individual. According to such a configuration, the arithmetic processing device 1 discontinues the calculation of the search for the eigensolution for the individual for which the eigensolution search is not complete, and estimates a fitness value using the second machine learning model 23 and the third machine learning model 24. As a result, the arithmetic processing device 1 is enabled to speed up the calculation of the fitness evaluation while maintaining the variety of eigensolutions indicated by the fitness.

Furthermore, when a search time for the search for the eigensolution used to calculate the fitness of each individual exceeds a threshold value, the arithmetic processing device 1 discontinues the calculation of the individual. According to such a configuration, the arithmetic processing device 1 is enabled to reduce the waiting time caused by the variation in the calculation time of the eigensolution search by using the search time as a criterion for termination of the eigensolution search.

Furthermore, when the number of searches for the eigensolution used to calculate the fitness of each individual exceeds a threshold value, the arithmetic processing device 1 discontinues the calculation of the individual. According to such a configuration, the arithmetic processing device 1 is enabled to reduce the waiting time caused by the variation in the calculation time of the eigensolution search by using the number of searches as a criterion for termination of the eigensolution search.

Furthermore, when a ratio of the individuals for which the search for the eigensolution used to calculate the fitness of each individual exceeds a threshold value, the arithmetic processing device 1 discontinues the calculation of the individual for which the eigensolution search is not complete. According to such a configuration, the arithmetic processing device 1 is enabled to reduce the waiting time caused by the variation in the calculation time of the eigensolution search by using the ratio of the individuals for which the eigensolution search is complete as a criterion for termination of the eigensolution search.

[Others]

Note that it has been described that the arithmetic processing device 1 generates the second machine learning model 23 based on the SAW intensity as one fitness for the input values from the first generation to the m-th generation. Then, the arithmetic processing device 1 predicts the SAW intensity for the input value from the input value of the (m+1)-th generation using the generated second machine learning model 23. However, it is not limited to this, and the arithmetic processing device 1 may continue the training even after the m-th generation and update the second machine learning model 23. Furthermore, the arithmetic processing device 1 may update the second machine learning model 23 in such a manner that it becomes the second machine learning model 23 using several generations immediately before the generation currently in operation.

Furthermore, the arithmetic processing device 1 has been described with an exemplary method of obtaining the eigensolution while predicting in which value range the eigensolution for the input value is located using the machine learning model. However, it is not limited to this, and the method of obtaining the eigensolution may be similarly applied to the evolutionary computation of the existing full-range search method.

Furthermore, it has been described that the arithmetic processing device 1 generates the third machine learning model 24 based on the value of the wavelength dependence (La/Lb) of the SAW shift distance as one fitness for the input values from the first generation to the m-th generation. Then, the arithmetic processing device 1 predicts the value of the wavelength dependence (La/Lb) of the SAW shift distance for the input value from the input value of the (m+1)-th generation using the generated third machine learning model 24. However, it is not limited to this, and the arithmetic processing device 1 may continue the training even after the m-th generation and update the third machine learning model 24. Furthermore, the arithmetic processing device 1 may update the third machine learning model 24 in such a manner that it becomes the third machine learning model 24 using several generations immediately before the generation currently in operation.

Furthermore, it has been described that the arithmetic processing device 1 generates the first machine learning model 22 for predicting in which value range the eigensolution for the input value is located on the basis of the eigensolutions for the input values of the first generation to the m-th generation searched by the full-range search. Then, the arithmetic processing device 1 predicts the solution candidate value range of the eigensolution for the input value from the input value of the (m+1)-th generation using the generated first machine learning model 22, and carries out the partial range search for searching for the eigensolution from the range of the solution candidate value range. However, it is not limited to this, and the arithmetic processing device 1 may continue the training even after the m-th generation and update the first machine learning model 22. Furthermore, the arithmetic processing device 1 may update the first machine learning model 22 according to the generation in which the partial range search is carried out. For example, the arithmetic processing device 1 may update the first machine learning model 22 in such a manner that it becomes the model using several generations immediately before the generation in which the partial range search is carried out.

Furthermore, each component of the arithmetic processing device 1 is not necessarily physically configured as illustrated in the drawings. For example, specific aspects of separation and integration of the arithmetic processing device 1 are not limited to the illustrated ones, and all or a part thereof may be functionally or physically separated or integrated in any unit according to various loads, use states, and the like. For example, the output unit 15 and the input/output holding unit 161 may be integrated as one unit. Furthermore, the HPC calculation unit 121 may be separated into a calculation unit for searching an eigensolution by the full-range search, a unit for calculating an objective function on the basis of the eigensolution, and a calculation unit for calculating fitness for an input value using the objective function. Furthermore, the storage unit 20 may be connected via a network as an external device of the arithmetic processing device 1.

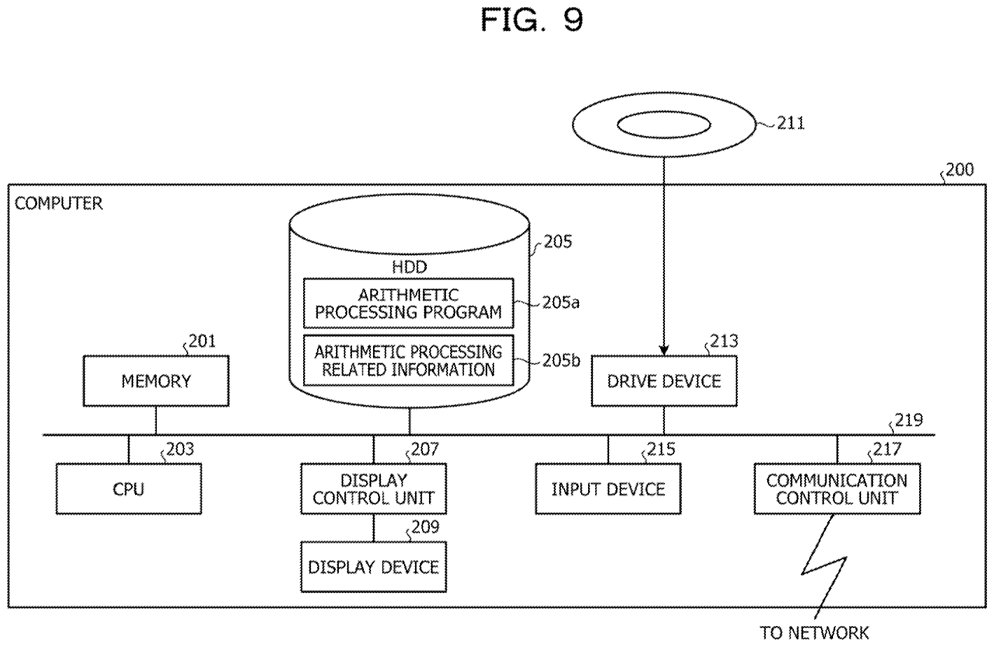

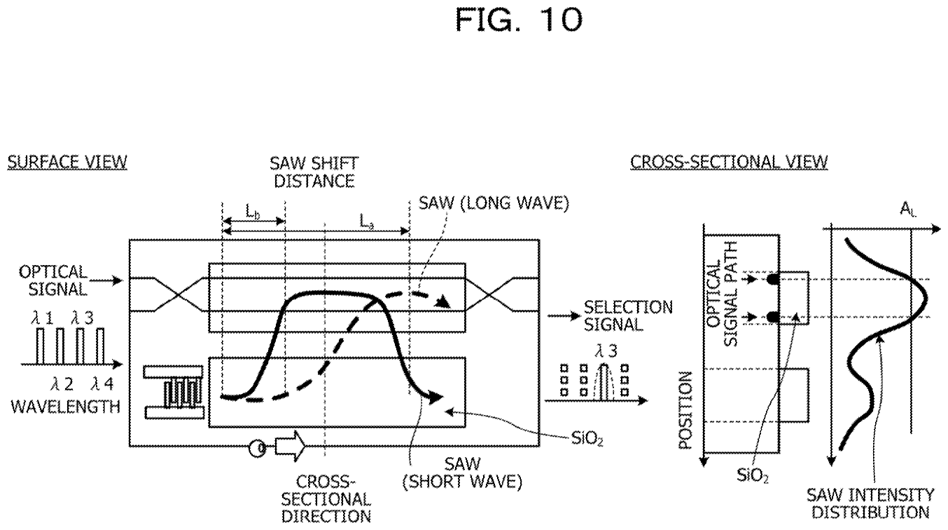

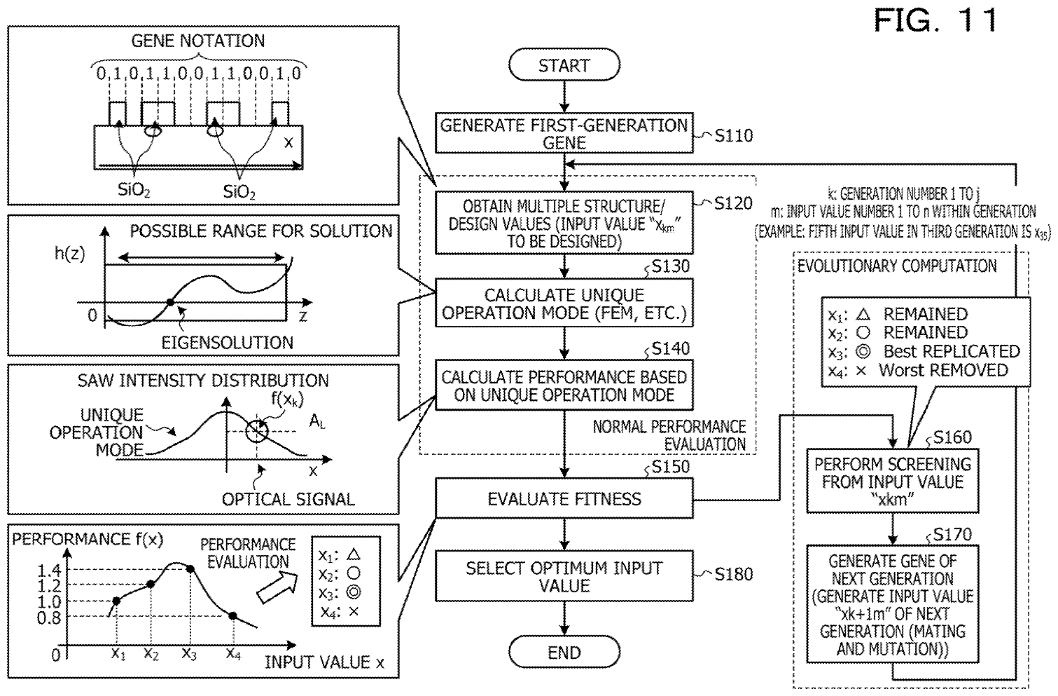

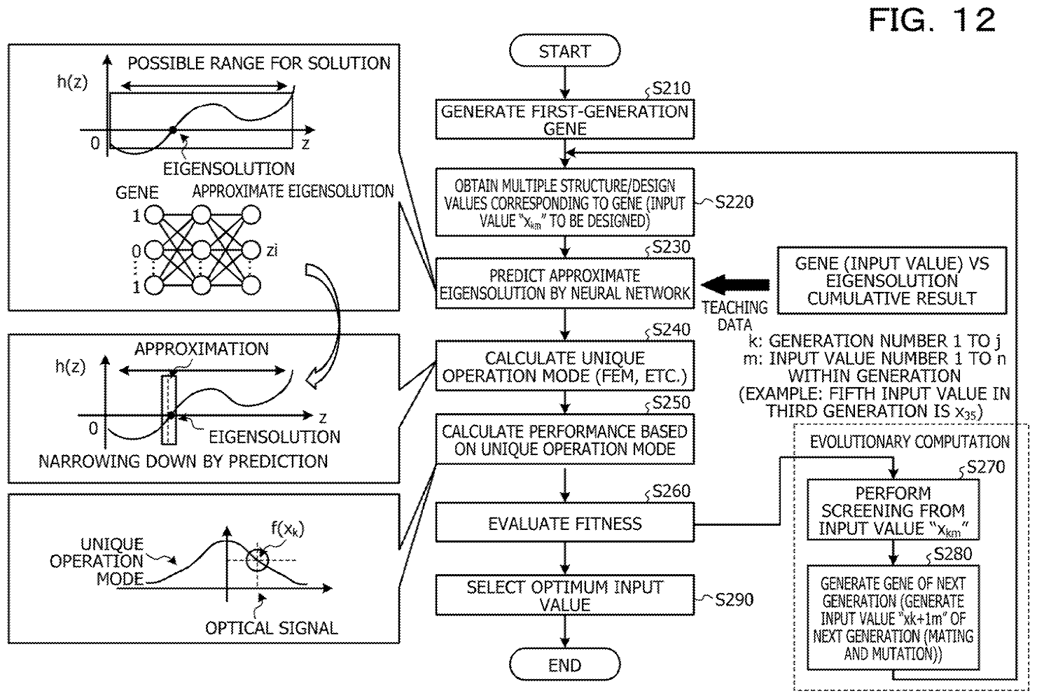

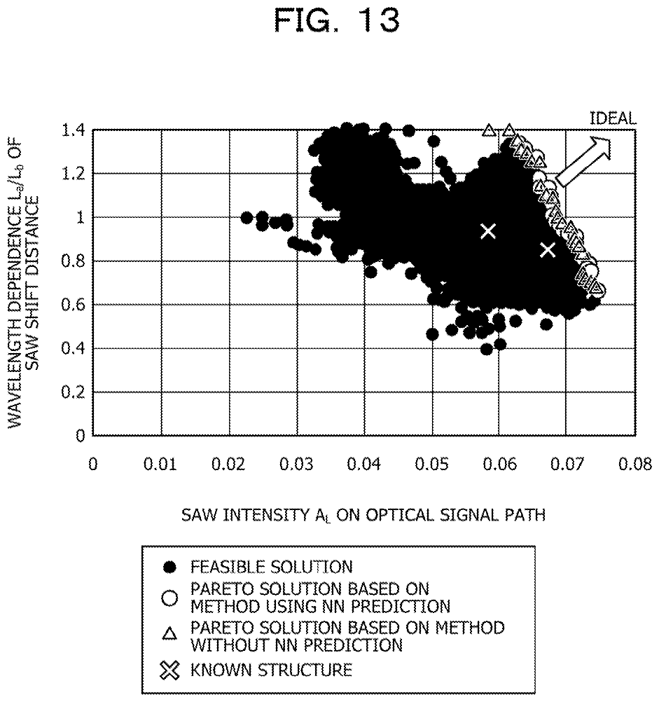

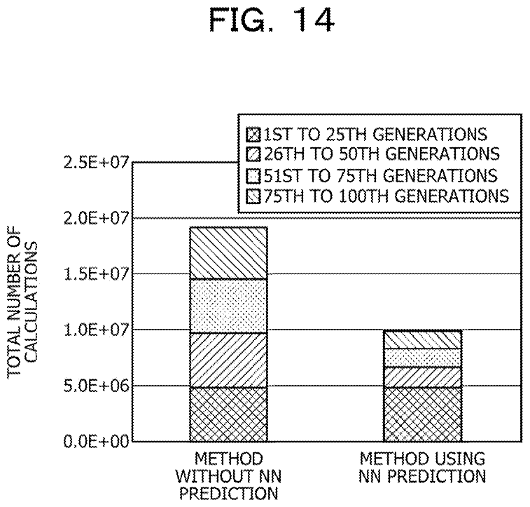

Furthermore, various types of processing described in the embodiment above may be implemented by a computer such as a personal computer or a workstation executing programs prepared in advance. In view of the above, hereinafter, an exemplary computer that executes an arithmetic processing program (evolutionary computation program for parallel computing) for implementing functions similar to those of the arithmetic processing device 1 illustrated in FIG. 1 will be described. FIG. 9 is a diagram illustrating an exemplary computer that executes the arithmetic processing program.

As illustrated in FIG. 9, a computer 200 includes a CPU 203 that executes various types of arithmetic processing, an input device 215 that receives data input from a user, and a display control unit 207 that controls a display device 209. Furthermore, the computer 200 includes a drive device 213 that reads a program and the like from a storage medium, and a communication control unit 217 that exchanges data with another computer via a network. Furthermore, the computer 200 includes a memory 201 that temporarily stores various types of information and a hard disk drive (HDD) 205. Additionally, the memory 201, the CPU 203, the HDD 205, the display control unit 207, the drive device 213, the input device 215, and the communication control unit 217 are coupled by a bus 219.

The drive device 213 is a device for a removable disk 210, for example. The HDD 205 stores an arithmetic processing program 205a and arithmetic processing related information 205b.

The CPU 203 reads the arithmetic processing program 205a, loads it into the memory 201, and executes it as a process. Such a process corresponds to each functional unit of the arithmetic processing device 1. The arithmetic processing related information 205b corresponds to the input/output storage unit 21, the first machine learning model 22, the second machine learning model 23, and the third machine learning model 24. Then, for example, the removable disk 210 stores each piece of information such as the arithmetic processing program 205a.

Note that the arithmetic processing program 205a may not necessarily be stored in the HDD 205 from the beginning. For example, the program is stored in a “portable physical medium” such as a flexible disk (FD), a compact disk read only memory (CD-ROM), a digital versatile disk (DVD), a magneto-optical disk, or an integrated circuit (IC) card, which is to be inserted into the computer 200. Then, the computer 200 may read the arithmetic processing program 205a from those media to execute it.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable recording medium storing an evolutionary computation program in which a processor included in a computer executes a process, the process comprising:
calculating fitness of a plurality of individuals based on a plurality of input in parallel in one generation;
discontinuing, when a predetermined reference value at an end of a search for an eigensolution used to calculate the fitness of each of the plurality of individuals exceeds a threshold value, calculation of an individual in which the predetermined reference value exceeds the threshold value; and
assigning an estimated fitness value to the individual for which the calculation is discontinued.

2. The non-transitory computer-readable recording medium according to claim 1, the process further comprising:
calculating a first eigensolution for a first individual based on a first input;
calculating a first fitness value from a fitness function that is calculated based on the first eigensolution;
generating a model that estimates the fitness based on the first input and the calculated first fitness value, wherein
the discontinuing includes discontinuing, when the predetermined reference value at an end of a search for an eigensolution for a second individual based on a second input exceeds the threshold value, calculation of the second individual based on the second input, and
the assigning includes:
estimating a fitness value for the second individual for which the calculation is discontinued by using the generated model, and
assigning the estimated fitness value to the individual.

3. The non-transitory computer-readable recording medium according to claim 1, wherein
the predetermined reference value includes a search time of the search for the eigensolution.

4. The non-transitory computer-readable recording medium according to claim 1, wherein
the predetermined reference value includes a number of searches of the search for the eigensolution.

5. The non-transitory computer-readable recording medium according to claim 1, wherein
the predetermined reference value includes a ratio of the individuals for which the search is complete to all the individuals in one generation.

6. The non-transitory computer-readable recording medium according to claim 1, wherein
the calculating includes predicting the eigensolution by using a predictor represented by a neural network and calculating the eigensolution by starting calculation of the search for the eigensolution from a prediction result.

7. An information processing apparatus comprising:
a memory; and
a processor coupled to the memory and configured to:
calculate fitness of a plurality of individuals based on a plurality of input in parallel in one generation,
discontinue, when a predetermined reference value at an end of a search for an eigensolution used to calculate the fitness of each of the plurality of individuals exceeds a threshold value, calculation of an individual in which the predetermined reference value exceeds the threshold value, and
assign an estimated fitness value to the individual for which the calculation is discontinued.

8. An evolutionary computation method comprising:
calculating fitness of a plurality of individuals based on a plurality of input in parallel in one generation;
discontinuing, when a predetermined reference value at an end of a search for an eigensolution used to calculate the fitness of each of the plurality of individuals exceeds a threshold value, calculation of an individual in which the predetermined reference value exceeds the threshold value; and
assigning an estimated fitness value to the individual for which the calculation is discontinued.
